(19) United States
(12) Patent Application Publication
(10) Pub. No.: US 2025/0184094 A1
(43) Pub. Date: Jun. 5, 2025

(54) UNIFIED TRANSMISSION CONFIGURATION INDICATOR FOR A SINGLE FREQUENCY NETWORK

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/836,987

(22) PCT Filed: Apr. 29, 2022
(86) PCT No.: PCT/CN2022/090492

§ 371 Date: Aug. 8, 2024

(51) Int. Cl. H04L 5/00; H04W 72/23

(52) U.S. Cl. CPC H04L 5/0091; H04W 72/23

(57) ABSTRACT

Various aspects of the present disclosure generally relate to wireless communication. In some aspects, a user equipment (UE) may receive an indication of a first group of one or more channels or reference signals (RSs) associated with a first transmission configuration indicator (TCI) state and a second group of one or more channels or RSs associated with a second TCI state for use in a single frequency network (SFN). The UE may receive or transmit an RS or a communication via the one or more channels using the first TCI state and the second TCI state in an SFN mode. Numerous other aspects are described.

### FIELD OF THE DISCLOSURE

Aspects of the present disclosure generally relate to wireless communication and to techniques and apparatuses for unified transmission configuration indicator for a single frequency network.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations and/or network nodes that support communication for a user equipment (UE) or multiple UEs. A UE may communicate with a base station and/or network node via downlink communications and uplink communications. “Downlink” (or “DL”) refers to a communication link from the base station and/or network node to the UE, and “uplink” (or “UL”) refers to a communication link from the UE to the base station and/or network node.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of a first group of one or more channels or reference signals (RSs) associated with a first transmission configuration indicator (TCI) state and a second group of one or more channels or RSs associated with a second TCI state for use in a single frequency network (SFN). The method may include receiving or transmitting an RS or a communication via the one or more channels using the first TCI state and the second TCI state in an SFN mode.

Some aspects described herein relate to a method of wireless communication performed by a network node. The method may include transmitting an indication of a first group of one or more channels or RSs associated with a first TCI state and a second group of one or more channels or RSs associated with a second TCI state for use in an SFN. The method may include transmitting or transmitting an RS or a communication via the one or more channels using the first TCI state and the second TCI state in an SFN mode.

Some aspects described herein relate to a UE for wireless communication. The user equipment may include a memory and one or more processors coupled to the memory. The one or more processors may be configured to receive an indication of a first group of one or more channels or RSs associated with a first TCI state and a second group of one or more channels or RSs associated with a second TCI state for use in an SFN. The one or more processors may be configured to receive or transmit an RS or a communication via the one or more channels using the first TCI state and the second TCI state in an SFN mode.

Some aspects described herein relate to a network node for wireless communication. The network node may include a memory and one or more processors coupled to the memory. The one or more processors may be configured to transmit an indication of a first group of one or more channels or RSs associated with a first TCI state and a second group of one or more channels or RSs associated with a second TCI state for use in an SFN. The one or more processors may be configured to transmit or transmitting an RS or a communication via the one or more channels using the first TCI state and the second TCI state in an SFN mode.

Some aspects described herein relate to a non-transitory computer-readable medium that stores a set of instructions for wireless communication by a UE. The set of instructions, when executed by one or more processors of the UE, may cause the UE to receive an indication of a first group of one or more channels or RSs associated with a first TCI state and a second group of one or more channels or RSs associated with a second TCI state for use in an SFN. The set of instructions, when executed by one or more processors of the UE, may cause the UE to receive or transmit an RS or a communication via the one or more channels using the first TCI state and the second TCI state in an SFN mode.

Some aspects described herein relate to a non-transitory computer-readable medium that stores a set of instructions for wireless communication by a network node. The set of instructions, when executed by one or more processors of the network node, may cause the network node to transmit an indication of a first group of one or more channels or RSs associated with a first TCI state and a second group of one or more channels or RSs associated with a second TCI state for use in an SFN. The set of instructions, when executed by one or more processors of the network node, may cause the network node to transmit or transmitting an RS or a communication via the one or more channels using the first TCI state and the second TCI state in an SFN mode.

Some aspects described herein relate to an apparatus for wireless communication. The apparatus may include means for receiving an indication of a first group of one or more channels or RSs associated with a first TCI state and a second group of one or more channels or RSs associated with a second TCI state for use in an SFN. The apparatus may include means for receiving or transmitting an RS or a communication via the one or more channels using the first TCI state and the second TCI state in an SFN mode.

Some aspects described herein relate to an apparatus for wireless communication. The apparatus may include means for transmitting an indication of a first group of one or more channels or RSs associated with a first TCI state and a second group of one or more channels or RSs associated with a second TCI state for use in an SFN. The apparatus may include means for transmitting or transmitting an RS or a communication via the one or more channels using the first TCI state and the second TCI state in an SFN mode.

Aspects generally include a method, apparatus, system, computer program product, non-transitory computer-readable medium, user equipment, base station, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network (RAN), in accordance with the present disclosure.

FIG. 5 is a diagram illustrating an example of multi-transmission reception point (TRP) communication, in accordance with the present disclosure.

FIG. 6 is a diagram illustrating an example associated with single-frequency network (SFN) communication, in accordance with the present disclosure.

FIG. 7 is a diagram illustrating an example associated with a unified transmission configuration indicator (TCI) for an SFN, in accordance with the present disclosure.

FIGS. 8 and 9 are diagrams illustrating example processes associated with a unified TCI for an SFN, in accordance with the present disclosure.

FIGS. 10 and 11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

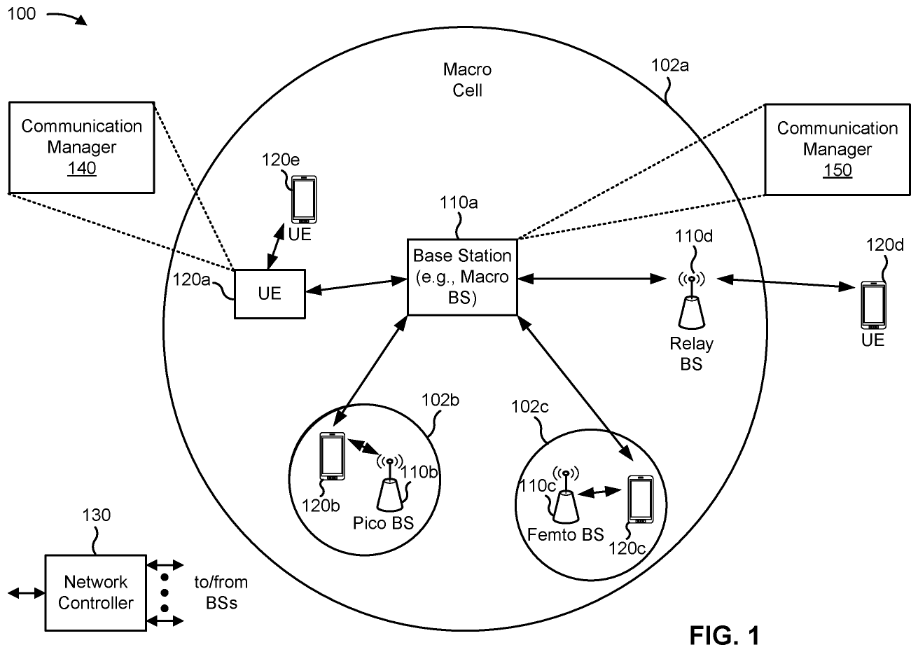

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of a first group of one or more channels or reference signals (RSs) associated with a first transmission configuration indicator (TCI) state and a second group of one or more channels or RSs associated with a second TCI state for use in a single frequency network (SFN); and receive or transmit an RS or a communication via the one or more channels using the first TCI state and the second TCI state in an SFN mode. Additionally, or alternatively, the communication manager 140 may perform one or more other operations described herein.

In some aspects, a network node (e.g., the base station 110, a component of a base station, or a component of a disaggregated base station, among other examples) may include a communication manager 150. As described in more detail elsewhere herein, the communication manager 150 may transmit an indication of a first group of one or more channels or RSs associated with a first TCI state and a second group of one or more channels or RSs associated with a second TCI state for use in an SFN; and transmit or transmitting an RS or a communication via the one or more channels using the first TCI state and the second TCI state in an SFN mode. Additionally, or alternatively, the communication manager 150 may perform one or more other operations described herein.

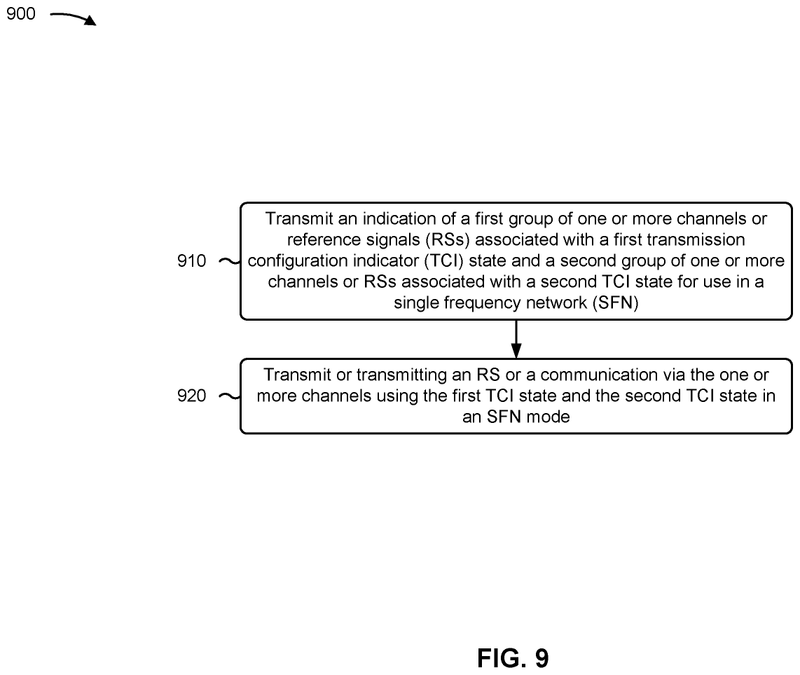

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

As indicated above, FIG. 1 is provided as an example. Other examples may differ from what is described with regard to FIG. 1.

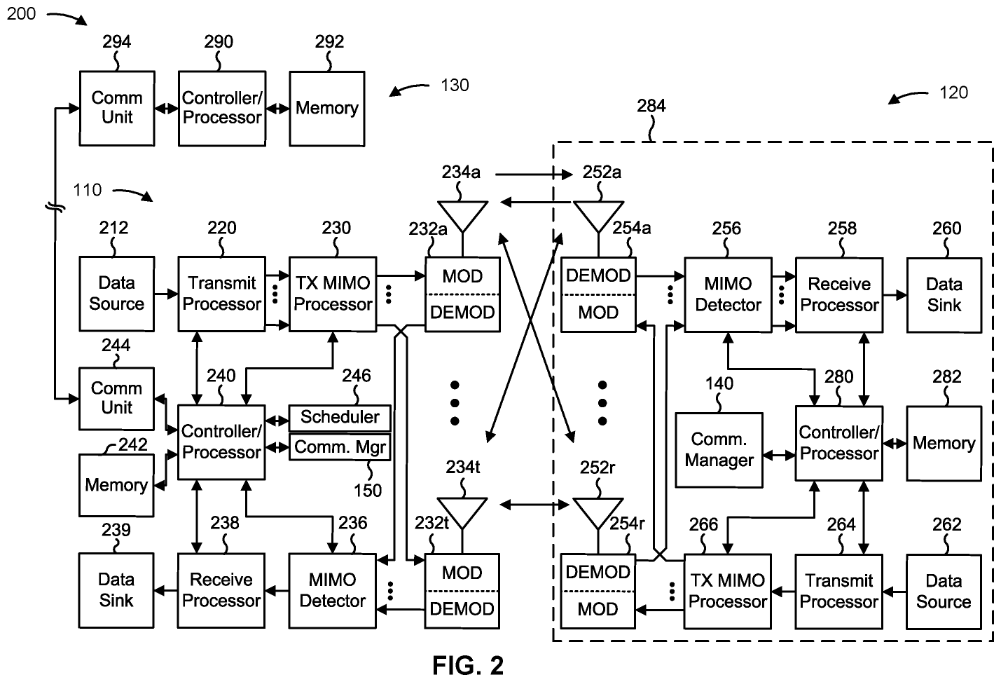

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

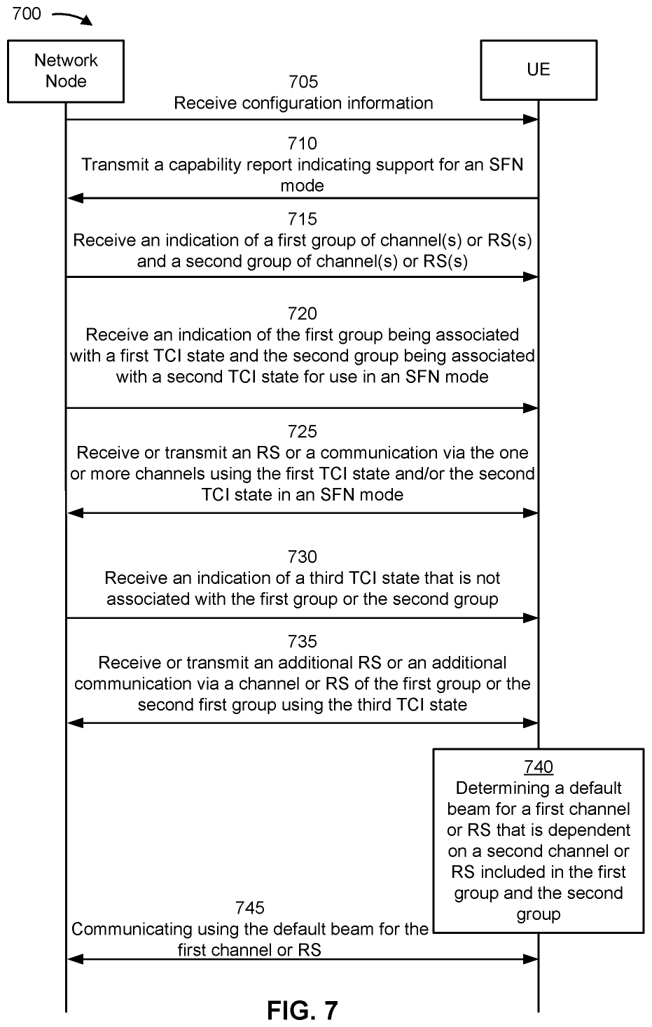

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

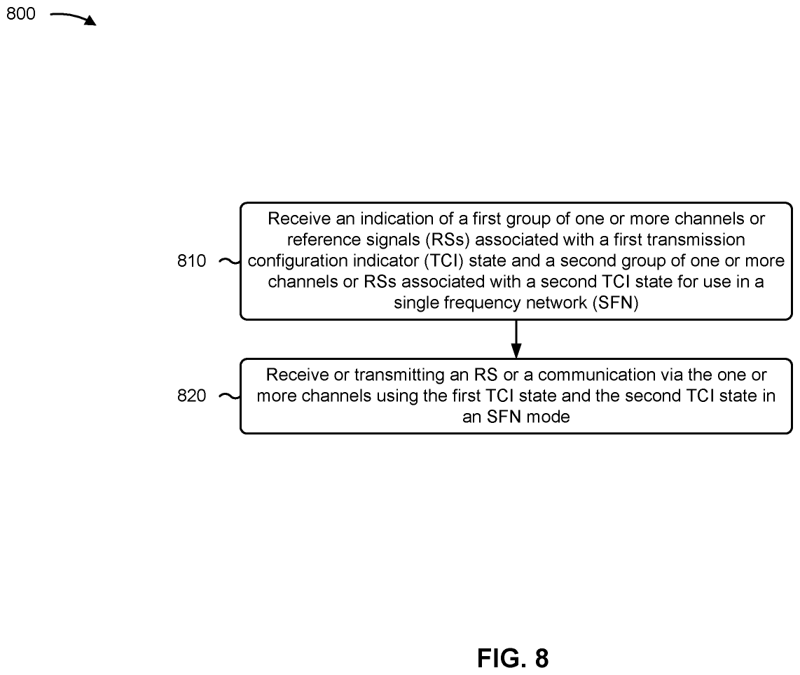

The controller/processor 240 of the base station 110, the controller/processor 280 of the UE 120, and/or any other component(s) of FIG. 2 may perform one or more techniques associated with a unified TCI for an SFN, as described in more detail elsewhere herein. In some aspects, the network node and/or an associated TRP described herein is the base station 110, is included in the base station 110, or includes one or more components of the base station 110 shown in FIG. 2.For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for receiving an indication of a first group of one or more channels or RSs associated with a first TCI state and a second group of one or more channels or RSs associated with a second TCI state for use in an SFN; and/or means for receiving or transmitting an RS or a communication via the one or more channels using the first TCI state and the second TCI state in an SFN mode. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting an indication of a first group of one or more channels or RSs associated with a first TCI state and a second group of one or more channels or RSs associated with a second TCI state for use in an SFN; and/or means for transmitting or transmitting an RS or a communication via the one or more channels using the first TCI state and the second TCI state in an SFN mode. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

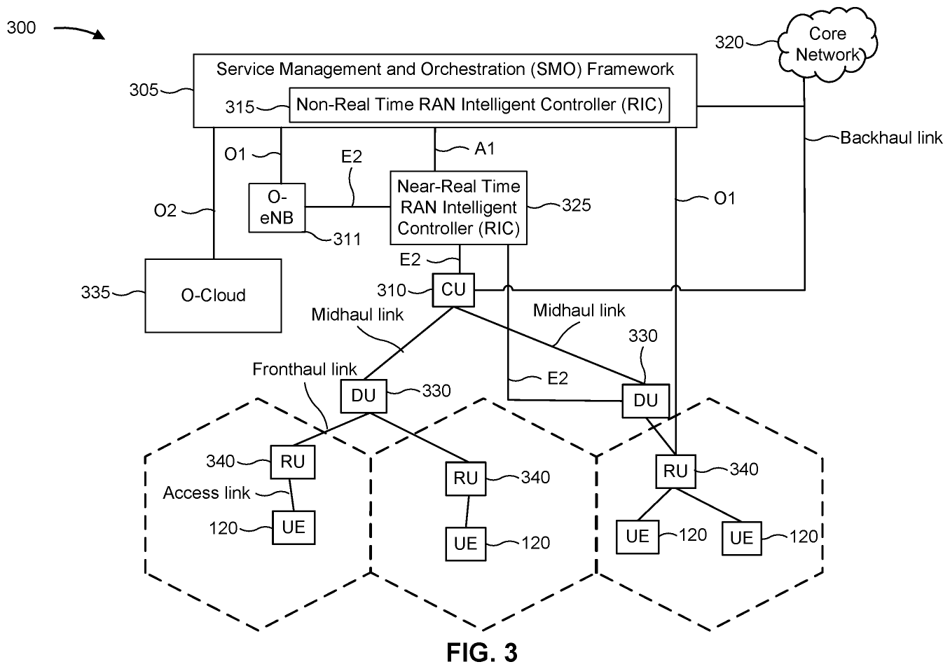

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a radio access node (RAN) node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more RF access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 335) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

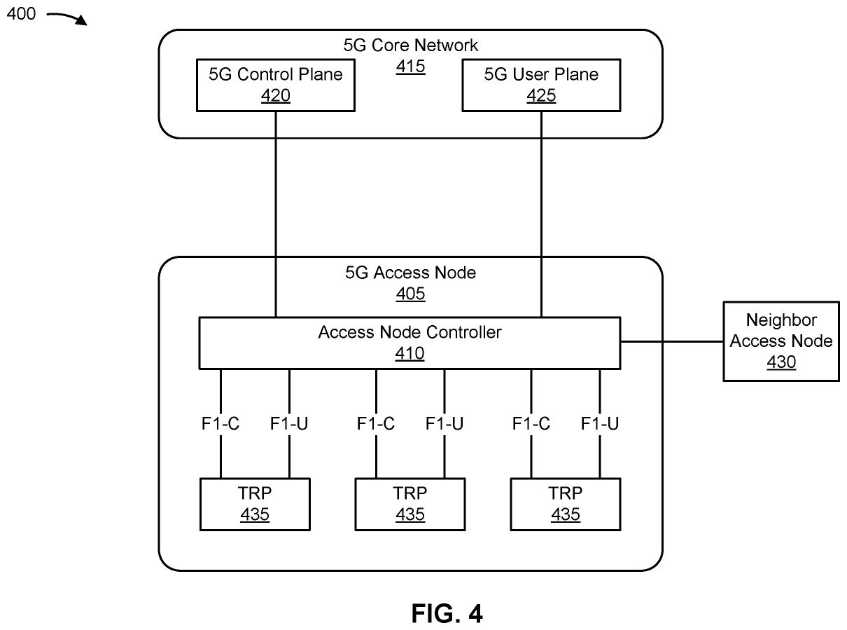

FIG. 4 illustrates an example logical architecture of a distributed RAN 400, in accordance with the present disclosure.

A 5G access node 405 may include an access node controller 410. The access node controller 410 may be a central unit (CU) of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a base station 110 described above in connection with FIG. 1. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi-co-location (QCL) relationships (e.g., different spatial parameters, different TCI states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

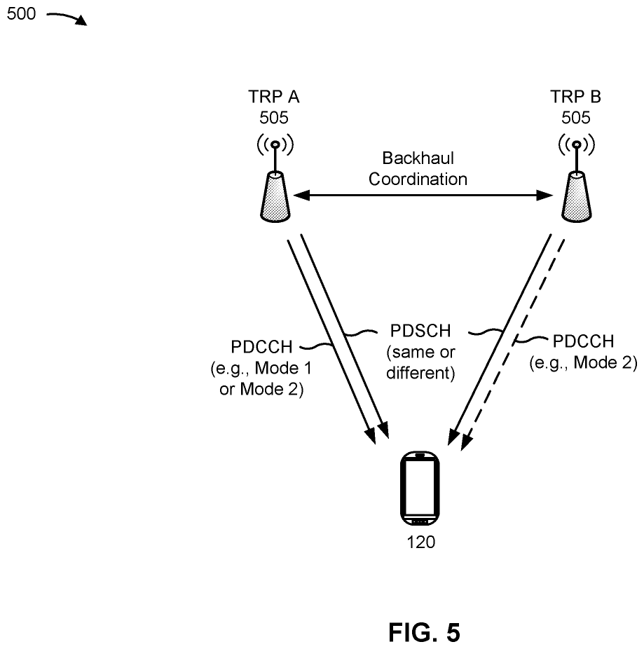

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110), and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

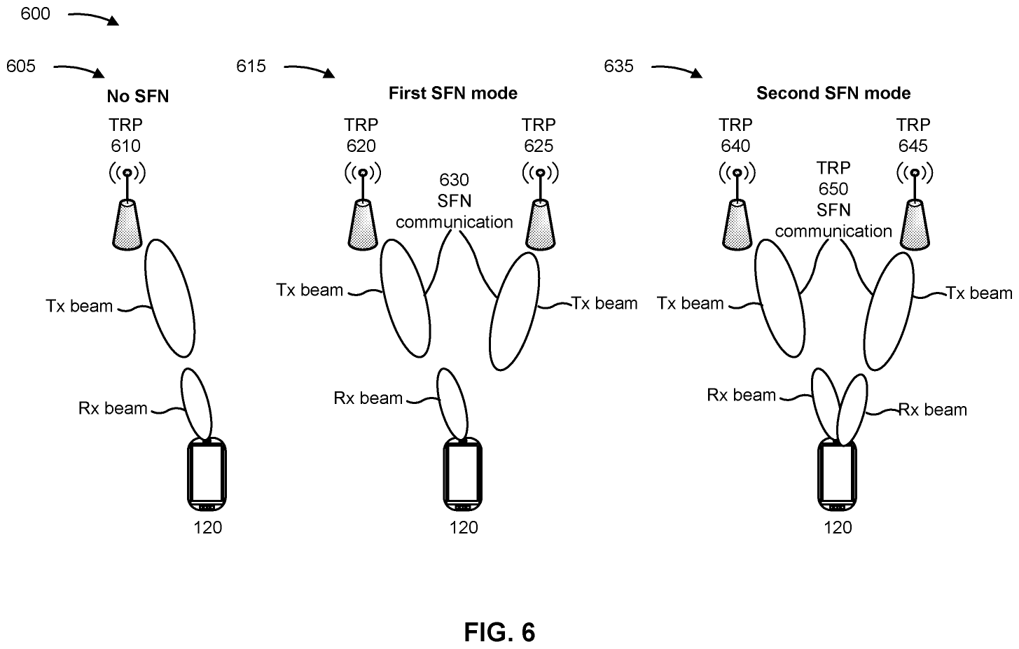

FIG. 6 is a diagram illustrating an example 600 associated with SFN communication, in accordance with the present disclosure.

As shown by reference number 605, an example of communications that do not use an SFN configuration is depicted. A TRP 610 may transmit communications using a transmit (Tx) beam to the UE 120. The transmit beam may be associated with a TCI state. The UE 120 may receive communications (e.g., transmitted by the TRP 610) using a receive (Rx) beam. For example, the UE 120 may identify the TCI state associated with the transmit beam and may use information provided by the TCI state to receive the communications.

As shown by reference number 615, an example of a first SFN mode is depicted. As shown in FIG. 6, a first TRP 620 (or a first base station 110) and a second TRP 625 (or a second base station 110) may transmit an SFN communication 630 to the UE 120. For example, the first TRP 620 and the second TRP 625 may transmit substantially the same information (e.g., the SFN communication 630) to the UE 120 using the same frequency domain resources and the same time domain resources. The first TRP 620 may transmit the SFN communication 630 using a first transmit beam. The second TRP 625 may transmit the SFN communication 630 using a second transmit beam. In the first SFN mode, the UE 120 may be unaware that the SFN communication 630 is transmitted on separate transmit beams (e.g., from different TRPs and/or different base stations 110). Accordingly, when the multiple base stations (and/or multiple TRPs) simultaneously transmit the same signal to a UE 120, the SFN configuration may be transparent to the UE 120, and the UE 120 may aggregate, or accumulate, the simultaneous signal transmissions from the multiple TRPs (and/or multiple base stations 110), which may provide higher signal quality or higher tolerance for multipath attenuation, among other benefits. For example, the UE 120 may receive the SFN communication 630 using a single receive beam (e.g., may use a single spatial receive direction, among other examples, to receive the SFN communication 630). In other words, TCI states of the different transmit beams used to transmit the SFN communication 630 may not be signaled to the UE 120.

As shown by reference number 635, an example of a second SFN mode is depicted. As shown in FIG. 6, a first TRP 640 (or a first base station 110) and a second TRP 645 (or a second base station 110) may transmit an SFN communication 650 to the UE 120. For example, the first TRP 640 and the second TRP 645 may transmit substantially the same information (e.g., the SFN communication 650) to the UE 120 using the same frequency domain resources and the same time domain resources. The first TRP 640 may transmit the SFN communication 650 using a first transmit beam. The second TRP 645 may transmit the SFN communication 650 using a second transmit beam. In the second SFN mode, the UE 120 may be aware that the SFN communication 650 is transmitted on separate transmit beams (e.g., from different TRPs and/or different base stations 110). For example, a first TCI state of the first transmit beam (e.g., associated with the first TRP 640) and a second TCI state of the second transmit beam (e.g., associated with the second TRP 645) may be signaled to the UE 120. For example, a base station 110 may transmit configuration information that indicates that the SFN communication 650 may be a combination of transmissions from different TRPs and/or different transmit beams. The UE 120 may use the information associated with the different TRPs and/or different transmit beams (e.g., the first TCI state and the second TCI state) to improve a reception performance of the SFN communication 650. For example, as shown in FIG. 6, the UE 120 may use different spatial directions (e.g., different receive beams) to receive the SFN communication 650 based at least in part on the TCI states of the transmit beam(s) associated with the SFN communication 650. This may improve a performance of the UE 120 because the UE 120 may receive the SFN communication 650 from different transmit beams and/or different TRPs with improved signal strength and/or signal quality, among other examples.

As indicated above, FIG. 6 is provided as an example. Other examples may differ from what is described with respect to FIG. 6.

In some networks, a unified TCI may be used to indicate a common TCI state for multiple channels, multiple RSs, or a channel and an RS. For example, a network may support different types of unified TCIs, such as Type 1 (where a joint downlink/uplink common TCI state indicates a common beam for at least one downlink channel and/or downlink RS in addition to at least one uplink channel and/or uplink RS), Type 2 (where a separate downlink common TCI state indicates a common beam for more than one downlink channel and/or downlink RS), and/or Type 3 (where a separate uplink common TCI state indicates a common beam for more than one uplink channel and/or uplink RS). Additionally, or alternatively, the network may support TCIs, such as Type 4 (where a separate downlink single channel or RS TCI state indicates a beam for a single downlink channel or RS), Type 5 (where a separate uplink single channel or uplink RS TCI state indicates a beam for a single uplink channel or uplink RS), and/or Type 6 (where uplink spatial relation info (SRI) indicates a beam for a single uplink channel or uplink RS), among other examples.

Based at least in part on supporting unified TCIs and/or single channel or RS TCIs, the network may conserve communication, power, and/or network resources that may have otherwise been consumed to signal each TCI state for each channel and/or RS separately. However, some networks support a unified TCI indication only in single TRP operation. In this case, a single TCI indication may be applied to different types of channels, including PDCCH, PDSCH, physical uplink shared channel (PUSCH), and/or physical uplink shared channel (PUCCH), among other examples. When using SFN, these networks may apply only separate TCI where the single TCI indication may be applied to one channel or RS and different channels or reference signals have different TCI indications. This may consume communication, power, and/or network resources that may have otherwise been conserved by using unified TCI states.

In some aspects described herein, a unified TCI indication may be used to support SFN operation, where an SFN channel or reference signal may be indicated with two unified TCIs. In some aspects, a UE that is capable of SFN transmission may be configured (e.g., via RRC or MAC control element (CE) signaling) to support the unified TCI indication for associated channels and/or reference signals based at least in part on one or more parameters. For example, the UE may be configured with a group of channels and/or RSs that may be applied to a pair of two TCIs. The group of channels may include any of PDCCH, PDSCH, CSI-RS, PUCCH, PUSCH, and SRS. For downlink TCIs, the group of channels or RSs may include PDCCH only, PDSCH only, or PDCCH and PDSCH. For uplink TCIs, the group of channels or RSs may include PUCCH only, PUSCH only, or PUCCH and PUSCH. For joint TCIs, the group of channels or RSs may include only PDCCH and PUCCH, only PDSCH and PUSCH, or all of PDCCH, PUCCH, PDSCH and PUSCH.

In some aspects, the groups may include a group of channels or reference signals per TCI. For example, each group may be associated with a TCI, which may be different from TCI of other groups (e.g., all other groups or only some other groups). Additionally, or alternatively, a channel or RS may be in multiple groups, with the multiple groups associated with different TCIs. If a channel or reference signal belongs to only one group for one TCI, the channel or reference signal is indicated as a non-SFN transmission. If a channel or reference signal belongs to multiple groups for different TCIs, the channel or reference signal is indicated as an SFN transmission using the multiple TCIs in the multiple groups. In some aspects, if no groups are configured to an indicated TCI, the indicated TCI is applicable to all feasible channels and/or reference signals. In some aspects, the groups may include a group of channels or reference signals per TCI group, where a TCI group may be predetermined and include multiple TCIs. For example, the multiple TCIs in a TCI group may have the same physical cell identification, or TRP identification.

Based at least in part on configuring a UE to use a unified TCI for an SFN, the UE and the network node may conserve communication, power, and/or network resources that may have otherwise been used to signal TCIs separately for each channel and RS used by the UE in the SFN. For example, the UE may receive a unified TCI to use for channels and/or RSs associated with a same TRP instead of receiving separate indications of TCIs for each channel and/or RS associated with the same TRP. In some aspects, channels and/or RSs associated with a same TRP of an SFN may be likely to have a same TCI based at least in part on the same TRP being in a same direction from the UE, while an additional TRP associated with one or more additional channels and/or RSs may be in a different direction from the UE and may have a different TCI.

In some aspects, a default beam for a channel and/or RS may be used before switching to an indicated beam (e.g., using a TCI state). In some aspects, the default beam for the channel and/or RS may be dependent on a TCI state of a different channel and/or RS. For a UE capable of SFN transmission and configured with groups of channels or reference signals per TCI, the UE may be configured to apply a default beam for a channel or reference signal based on a different channel or reference signal that belongs to multiple groups. In some aspects, the UE may apply a TCI associated with one of the multiple groups based at least in part on the TCI having a highest TCI identification or a lowest TCI identification among TCIs of the multiple groups. In some aspects, the UE may apply the TCI associated with one of the multiple groups based at least in part on the TCI being indicated for a group having a highest group identification or a lowest group identification among the multiple groups.

For example, a PDCCH may be configured to belong to two groups of different TCIs and a default beam for a PDSCH may be based at least in part on (e.g., dependent on) the PDCCH. The PDSCH may be scheduled within a time offset (e.g., timedurationforQCL) where a default beam is to be applied to the PDSCH, and the default beam is based on a beam of the PDCCH. In some aspects, the UE may identify, and configure as the default beam for the PDSCH, a TCI with a lowest or highest TCI identification (e.g., based at least in part on a configuration of the UE) of the two groups configured for the PDCCH. In some aspects, the UE may identify, and configure as the default beam for the PDSCH, a TCI associated with a group having a lowest or highest group identification (e.g., based at least in part on a configuration of the UE) of the two groups configured for the PDCCH. In some aspects, the UE may be configured to identify the default beam using a parameter (e.g., highest or lowest TCI identification or group identification, among other examples) via signaling from the network (e.g., a network node) or via a communication protocol, among other examples.

Based at least in part on the UE being configured to identify a default beam for a channel or RS, with the default beam being dependent on a TCI state of an additional channel or RS, the UE and the network node may be synchronized in the identification of the default beam. In this way, the network node may receive a communication or RS via the default beam with reduced errors when compared to attempting to receive the communication or RS without synchronization, which may conserve computing, communication, power, and/or network resources that may have otherwise been used to detect and/or correct the errors in receiving the communications or RSs.

FIG. 7 is a diagram of an example 700 associated with a unified TCI for an SFN, in accordance with the present disclosure. As shown in FIG. 7, a network node (e.g., base station 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 7. In some aspects, the network node may be associated with multiple TRPs, relays, and/or forwarding nodes, among other examples. In some aspects, the multiple TRPs, relays, and/or forwarding nodes may be in different directions from the UE. In some aspects, communications between the UE and the multiple TRPs, relays, and/or forwarding nodes may traverse different beam paths and/or may be associated with different TCI states and/or SRI.

As shown by reference number 705, the network node may transmit, and the UE may receive, configuration information. In some aspects, the UE may receive the configuration information via one or more of RRC signaling, one or more MAC CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to transmit a capability report to indicate support for an SFN mode. In some aspects, the configuration information may indicate that the UE is to apply a unified TCI state to multiple channels and/or RSs. In some aspects, the configuration information may indicate that the UE is to identify a default beam for a channel or RS, with the default beam being dependent on a TCI state of an additional channel or RS that is associated with multiple TCI states. For example, the additional channel or RS may be included in multiple groups of channels and/or RSs and the multiple groups may be configured with different TCI states. The configuration information may indicate how the UE is to select the default beam from the different TCI state. For example, the configuration information may indicate to select and/or apply a TCI state having a highest TCI state identification of the different TCI state, a TCI state having a lowest TCI state identification of the different TCI state, a TCI state associated with (e.g., configured for) a group of the multiple groups having a highest group identification, or a TCI state associated with (e.g., configured for) a group of the multiple groups having a lowest group identification, among other examples. In some aspects, configuration information may indicate that the network node will signal how the UE is to select and/or apply the default beam in a subsequent communication (e.g., before selection and/or application of the default beam).

The UE may configure itself based at least in part on the configuration information. In some aspects, the UE may be configured to perform one or more operations described herein based at least in part on the configuration information.

As shown by reference number 710, the UE may transmit, and the network node may receive, a capabilities report indicating support for an SFN mode. In some aspects, the capabilities report may indicate support for SFN modes and/or support for different parameters of an SFN mode. For example, the UE may indicate support for unified TCI states in the SFN mode. In some aspects, the UE may indicate support of a number of groups of channels and/or RSs that may be associated with different TCI states. In some aspects, the UE may indicate support for communicating with the network node via a number of different TCI states. In some aspects, the UE may indicate whether the UE supports simultaneous communication via different TCI states.

As shown by reference number 715, the UE may receive, and the network node may transmit, an indication of a first group of one or more channels and/or RSs and a second group of one or more channels and/or RSs. In some aspects, the indication may further indicate additional groups of one or more channels and/or RSs. In some aspects, the UE may receive the indication via RRC signaling and/or via MAC CE signaling.

In some aspects, one or more channels or RSs are included in the first group and the second group. In some aspects, inclusion in multiple groups (e.g., the first group, the second group, and/or an additional group) may indicate whether a channel or RS is configured for SFN. For example, based at least in part on a first channel or first RS being included in only one of the first group or the second group, the first channel or first RS may be configured for non-SFN transmission. Additionally, or alternatively, based at least in part on a second channel or second RS being included in both of the first group and the second group, the second channel or second RS may be configured for SFN transmission.

In some aspects, the first group of one or more channels or RSs and the second group of one or more channels or RSs are a single group of one or more channels or RSs. For example, the first group and the second group may fully overlap. In some aspects, one or more channels or RSs of the single group of one or more channels or RSs may be configured for communication via the first TCI state and the second TCI state. For example, the first group may be configured for communication via the first TCI state and the second group may be configured for communication via the second TCI state. Based at least in part on the first group fully overlapping with the second group, the one or more channels or RSs of both groups may be configured to communicate via both of the first TCI state and the second TCI state. In some aspects, the first group and the second group may be configured as a single group, with the single group being configured for communication via both of the first TCI state and the second TCI state.

In some aspects, the first group may include channels of a same type (e.g., data channels, such as PDSCH, or control channels, such as PDCCH, among other examples) or may include channels of different types. For example, the first group and/or the second group may include downlink control channels only, downlink data channels only, or a combination of downlink control channels and downlink data channels. In some aspects, the first group may include channels of a same communication direction (e.g., uplink or downlink), RSs of a same communication direction, or a combination of RSs and channels of a same communication direction. For example, the first group and/or the second group may include downlink channels only or uplink channels only.

As shown by reference number 720, the UE may receive, and the network node may transmit, an indication of the first group being associated with a first TCI state and the second group being associated with a second TCI state for use in an SFN mode. For example, the UE may receive an indication of the first group of one or more channels or RSs associated with the first TCI state and the second group of one or more channels or RSs associated with the second TCI state for use in an SFN.

In some aspects, the UE may receive the indication of the first group being associated with a first TCI state and the second group being associated with a second TCI state in a same communication as the indication of the first group of one or more channels and/or RSs and the second group of one or more channels and/or RSs. In some aspects, the UE may receive the indication via RRC signaling (e.g., a configuration), MAC CE signaling (e.g., a dynamic control element), and/or DCI, among other examples.

As shown by reference number 725, the UE may transmit and the network node may receive, or the UE may receive and the network node may transmit, an RS or a communication via the one or more channels using the first TCI state and/or the second TCI state in an SFN mode.

As shown by reference number 730, the UE may receive an indication of a third TCI state that is not associated with the first group or the second group. In some aspects, the network node may indicate a third TCI state that is not associated with the first group or the second group. In some aspects, the third TCI state may have no channels or RSs assigned. In this case, the UE may be configured to apply and/or associate the third TCI to all feasible channels and/or RSs (e.g., based at least in part on a number of TCI states that the UE supports for a single channel or RS and a number of TCI states already associated with the single channel or RS, among other examples). For example, the third TCI state may be associated with one or more channels and/or RSs of the first group and one or more channels and/or RSs of the second group based at least in part on the third TCI state having no channels or RSs assigned.

As shown by reference number 735, the UE may transmit and the network node may receive, or the UE may receive and the network node may transmit, an additional RS or an additional communication via a channel or RS of the first group or the second first group using the third TCI state. In some aspects, receiving or transmitting the additional RS or the additional communication via the third TCI state is allowed based at least in part on a configuration or a capability of the UE (e.g., indicated to the network node).

As shown by reference number 740, the UE may determine a default beam for a first channel or RS that is dependent on a second channel or RS included in the first group and the second group. For example, the UE may determine the default beam for the first channel or RS based at least in part on dependency on the second channel or RS, with the second channel or RS being included in the first group and the second group, and the first TCI state being different from the second TCI state.

The UE may determine the default beam from a TCI state associated with the first group or the second group based at least in part on a configuration of the UE (e.g., indicated by the network node and/or configured in a communication protocol, among other examples). For example, the UE may apply the first TCI state based at least in part on the first TCI state having a first TCI identification that is higher than a second TCI identification of the second TCI state or may apply the second TCI state based at least in part on the second TCI identification being lower than the first TCI identification. In some aspects, the UE may apply the first TCI state based at least in part on the first group having a first group identification that is higher than a second group identification of the second group, or may apply the second TCI state based at least in part on the second group identification being lower than the second group identification.

As shown by reference number 745, the UE and the network node may communicate using the default beam for the first channel or RS. For example, the UE may use, as the default beam, a beam identified by the first TCI state or the second TCI state based at least in part on a configuration of the UE.

Based at least in part on configuring a UE to use a unified TCI for an SFN, the UE and the network node may conserve communication, power, and/or network resources that may have otherwise been used to signal TCI states separately for each channel and RS used by the UE in the SFN. Based at least in part on the UE being configured to identify a default beam for a channel or RS, with the default beam being dependent on a TCI state of an additional channel or RS, the UE and the network node may be synchronized in the identification of the default beam. In this way, the network node may receive a communication or RS via the default beam with reduced errors when compared to attempting to receive the communication or RS without synchronization, which may conserve computing, communication, power, and/or network resources that may have otherwise been used to detect and/or correct the errors in receiving the communications or RSs.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with unified TCI for an SFN.

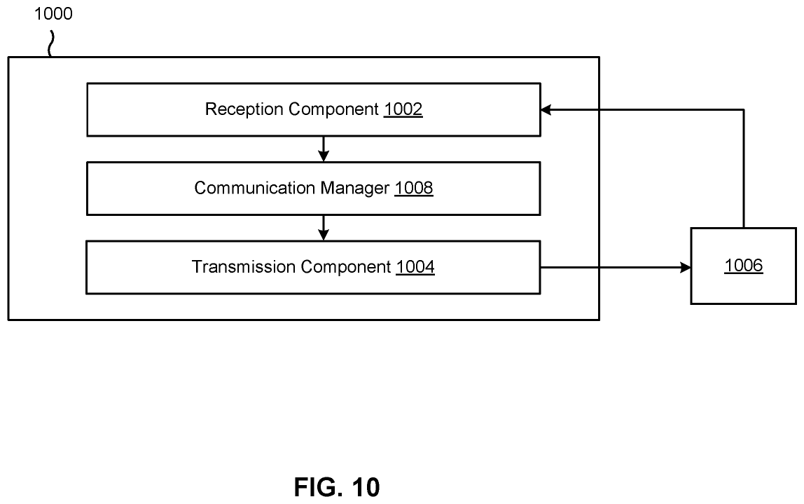

As shown in FIG. 8, in some aspects, process 800 may include receiving an indication of a first group of one or more channels or RSs associated with a first TCI state and a second group of one or more channels or RSs associated with a second TCI state for use in an SFN (block 810). For example, the UE (e.g., using communication manager 140 and/or reception component 1002, depicted in FIG. 10) may receive an indication of a first group of one or more channels or RSs associated with a first TCI state and a second group of one or more channels or RSs associated with a second TCI state for use in an SFN, as described above.

As further shown in FIG. 8, in some aspects, process 800 may include receiving or transmitting an RS or a communication via the one or more channels using the first TCI state and the second TCI state in an SFN mode (block 820). For example, the UE (e.g., using communication manager 140 and/or reception component 1002, depicted in FIG. 10) may receive or transmit an RS or a communication via the one or more channels using the first TCI state and the second TCI state in an SFN mode, as described above.

Process 800 may include additional aspects, such as any single aspect or any combination of aspects described below and/or in connection with one or more other processes described elsewhere herein.

In a first aspect, process 800 includes transmitting an indication of support for the SFN mode.

In a second aspect, alone or in combination with the first aspect, the first group of one or more channels or RSs and the second group of one or more channels or RSs are a single group of one or more channels or RSs, and wherein one or more channels or RSs of the single group of one or more channels or RSs are configured for communication via the first TCI state and the second TCI state.

In a third aspect, alone or in combination with one or more of the first and second aspects, one or more of the first group of one or more channels or RSs or the second group of one or more channels or RSs comprise downlinking control channels only, downlinking data channels only, or one or more downlink control channels and one or more downlink data channels.

In a fourth aspect, alone or in combination with one or more of the first through third aspects, the first group of one or more channels or RSs includes at least one channel of the second group of one or more channels or RSs.

In a fifth aspect, alone or in combination with one or more of the first through fourth aspects, basing at least in part on a first channel or first RS being included in only one of the first group of one or more channels or RSs or the second group of one or more channels or RSs, the first channel or first RS is configured for non-SFN transmission, and wherein basing at least in part on a second channel or second RS being included in both of the first group of one or more channels or RSs and the second group of one or more channels or RSs, the second channel or second RS is configured for SFN transmission.

In a sixth aspect, alone or in combination with one or more of the first through fifth aspects, basing at least in part on a third TCI state having no channels or RSs assigned, the first group of one or more channels or RSs and the second group of one or more channels or RSs are also associated with the third TCI state.

In a seventh aspect, alone or in combination with one or more of the first through sixth aspects, process 800 includes receiving or transmitting an additional RS or an additional communication via the third TCI state, wherein receiving or transmitting the additional RS or the additional communication via the third TCI state is allowed based at least in part on a configuration or a capability of the UE.

In an eighth aspect, alone or in combination with one or more of the first through seventh aspects, process 800 includes determining a default beam for a first channel or RS based at least in part on dependency on a second channel or RS, wherein the second channel or RS is included in the first group of one or more channels or RSs and the second group of one or more channels or RSs, and wherein the first TCI state is different from the second TCI state.

In a ninth aspect, alone or in combination with one or more of the first through eighth aspects, determining the default beam for the first channel or RS based at least in part on dependency on the second channel or RS comprises applying the first TCI state based at least in part on the first TCI state having a first TCI identification that is higher than a second TCI identification of the second TCI state, applying the second TCI state based at least in part on the second TCI identification being lower than the first TCI identification, applying the first TCI state based at least in part on the first group of one or more channels or RSs having a first group identification that is higher than a second group identification of the second group of one or more channels or RSs, or applying the second TCI state based at least in part on the second group identification being lower than the second group identification.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., base station 110, a CU, a DU, and/or an RU, among other examples), performs operations associated with unified TCI for an SFN.

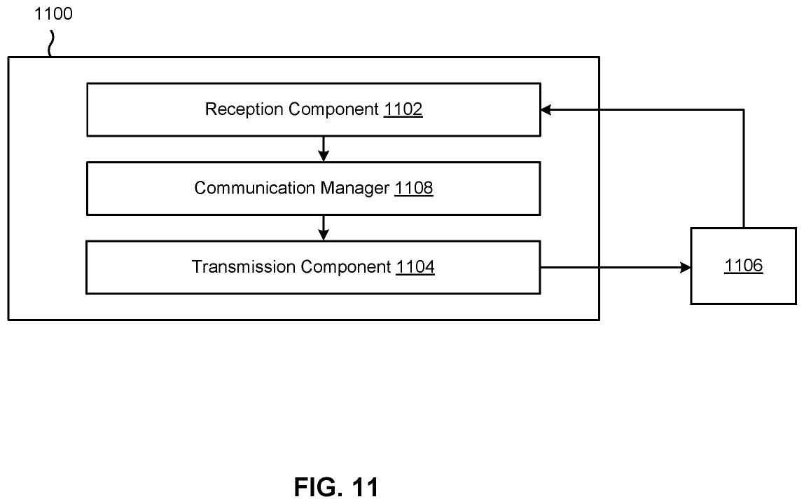

As shown in FIG. 9, in some aspects, process 900 may include transmitting an indication of a first group of one or more channels or RSs associated with a first TCI state and a second group of one or more channels or RSs associated with a second TCI state for use in an SFN (block 910). For example, the network node (e.g., using communication manager 150 and/or transmission component 1104, depicted in FIG. 11) may transmit an indication of a first group of one or more channels or RSs associated with a first TCI state and a second group of one or more channels or RSs associated with a second TCI state for use in an SFN, as described above.

As further shown in FIG. 9, in some aspects, process 900 may include transmitting or transmitting an RS or a communication via the one or more channels using the first TCI state and the second TCI state in an SFN mode (block 920). For example, the network node (e.g., using communication manager 150 and/or transmission component 1104, depicted in FIG. 11) may transmit or transmitting an RS or a communication via the one or more channels using the first TCI state and the second TCI state in an SFN mode, as described above.

Process 900 may include additional aspects, such as any single aspect or any combination of aspects described below and/or in connection with one or more other processes described elsewhere herein.

In a first aspect, process 900 includes receiving an indication of support for the SFN mode.

In a second aspect, alone or in combination with the first aspect, the first group of one or more channels or RSs and the second group of one or more channels or RSs are a single group of one or more channels or RSs, and wherein one or more channels or RSs of the single group of one or more channels or RSs are configured for communication via the first TCI state and the second TCI state.

In a third aspect, alone or in combination with one or more of the first and second aspects, one or more of the first group of one or more channels or RSs or the second group of one or more channels or RSs comprise downlinking control channels only, downlinking data channels only, or one or more downlink control channels and one or more downlink data channels.

In a fourth aspect, alone or in combination with one or more of the first through third aspects, the first group of one or more channels or RSs includes at least one channel of the second group of one or more channels or RSs.

In a fifth aspect, alone or in combination with one or more of the first through fourth aspects, basing at least in part on a first channel or first RS being included in only one of the first group of one or more channels or RSs or the second group of one or more channels or RSs, the first channel or first RS is configured for non-SFN transmission, and wherein basing at least in part on a second channel or second RS being included in both of the first group of one or more channels or RSs and the second group of one or more channels or RSs, the second channel or second RS is configured for SFN transmission.

In a sixth aspect, alone or in combination with one or more of the first through fifth aspects, basing at least in part on a third TCI state having no channels or RSs assigned, the first group of one or more channels or RSs and the second group of one or more channels or RSs are also associated with the third TCI state.

In a seventh aspect, alone or in combination with one or more of the first through sixth aspects, process 900 includes receiving or transmitting an additional RS or an additional communication via the third TCI state, wherein receiving or transmitting the additional RS or the additional communication via the third TCI state is allowed based at least in part on a configuration or a capability of a UE associated with the additional RS or the additional communication.

In an eighth aspect, alone or in combination with one or more of the first through seventh aspects, process 900 includes indicating a default beam for a first channel or RS based at least in part on dependency on a second channel or RS, wherein the second channel or RS is included in the first group of one or more channels or RSs and the second group of one or more channels or RSs, and wherein the first TCI state is different from the second TCI state.

In a ninth aspect, alone or in combination with one or more of the first through eighth aspects, signaling the default beam for the first channel or RS based at least in part on dependency on the second channel or RS comprises indicating to apply the first TCI state based at least in part on the first TCI state having a first TCI identification that is higher than a second TCI identification of the second TCI state, indicating to apply the second TCI state based at least in part on the second TCI identification being lower than the first TCI identification, indicating to apply the first TCI state based at least in part on the first group of one or more channels or RSs having a first group identification that is higher than a second group identification of the second group of one or more channels or RSs, or indicating to apply the second TCI state based at least in part on the second group identification being lower than the second group identification.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (e.g., the communication manager 140).

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive an indication of a first group of one or more channels or RSs associated with a first TCI state and a second group of one or more channels or RSs associated with a second TCI state for use in an SFN. The reception component 1002 may receive or transmit an RS or a communication via the one or more channels using the first TCI state and the second TCI state in an SFN mode.

The transmission component 1004 may transmit an indication of support for the SFN mode.

The reception component 1002 may receive or transmit an additional RS or an additional communication via the third TCI state wherein receiving or transmitting the additional RS or the additional communication via the third TCI state is allowed based at least in part on a configuration or a capability of the UE.

The communication manager 1008 may determine a default beam for a first channel or RS based at least in part on dependency on a second channel or RS wherein the second channel or RS is included in the first group of one or more channels or RSs and the second group of one or more channels or RSs, and wherein the first TCI state is different from the second TCI state.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108 (e.g., the communication manager 150).

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The transmission component 1104 may transmit an indication of a first group of one or more channels or RSs associated with a first TCI state and a second group of one or more channels or RSs associated with a second TCI state for use in an SFN. The transmission component 1104 may transmit or transmitting an RS or a communication via the one or more channels using the first TCI state and the second TCI state in an SFN mode.

The reception component 1102 may receive an indication of support for the SFN mode.

The reception component 1102 may receive or transmit an additional RS or an additional communication via the third TCI state wherein receiving or transmitting the additional RS or the additional communication via the third TCI state is allowed based at least in part on a configuration or a capability of a UE associated with the additional RS or the additional communication.

The transmission component 1104 and/or the communication manager 1108 may indicate a default beam for a first channel or RS based at least in part on dependency on a second channel or RS wherein the second channel or RS is included in the first group of one or more channels or RSs and the second group of one or more channels or RSs, and wherein the first TCI state is different from the second TCI state.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving an indication of a first group of one or more channels or reference signals (RSs) associated with a first transmission configuration indicator (TCI) state and a second group of one or more channels or RSs associated with a second TCI state for use in a single frequency network (SFN); and receiving or transmitting an RS or a communication via the one or more channels using the first TCI state and the second TCI state in an SFN mode.

Aspect 2: The method of Aspect 1, further comprising: transmitting an indication of support for the SFN mode.

Aspect 3: The method of any of Aspects 1-2, wherein the first group of one or more channels or RSs and the second group of one or more channels or RSs are a single group of one or more channels or RSs, and wherein one or more channels or RSs of the single group of one or more channels or RSs are configured for communication via the first TCI state and the second TCI state.

Aspect 4: The method of any of Aspects 1-3, wherein one or more of the first group of one or more channels or RSs or the second group of one or more channels or RSs comprise: downlink control channels only, downlink data channels only, or one or more downlink control channels and one or more downlink data channels.

Aspect 5: The method of any of Aspects 1-4, wherein the first group of one or more channels or RSs includes at least one channel of the second group of one or more channels or RSs.

Aspect 6: The method of any of Aspects 1-5, wherein based at least in part on a first channel or first RS being included in only one of the first group of one or more channels or RSs or the second group of one or more channels or RSs, the first channel or first RS is configured for non-SFN transmission, and wherein based at least in part on a second channel or second RS being included in both of the first group of one or more channels or RSs and the second group of one or more channels or RSs, the second channel or second RS is configured for SFN transmission.

Aspect 7: The method of any of Aspects 1-6, wherein based at least in part on a third TCI state having no channels or RSs assigned, the first group of one or more channels or RSs and the second group of one or more channels or RSs are also associated with the third TCI state.

Aspect 8: The method of Aspect 7, further comprising receiving or transmitting an additional RS or an additional communication via the third TCI state, wherein receiving or transmitting the additional RS or the additional communication via the third TCI state is allowed based at least in part on a configuration or a capability of the UE.

Aspect 9: The method of any of Aspects 1-8, further comprising: determining a default beam for a first channel or RS based at least in part on dependency on a second channel or RS, wherein the second channel or RS is included in the first group of one or more channels or RSs and the second group of one or more channels or RSs, and wherein the first TCI state is different from the second TCI state.

Aspect 10: The method of Aspect 9, wherein determining the default beam for the first channel or RS based at least in part on dependency on the second channel or RS comprises: applying the first TCI state based at least in part on the first TCI state having a first TCI identification that is higher than a second TCI identification of the second TCI state, applying the second TCI state based at least in part on the second TCI identification being lower than the first TCI identification, applying the first TCI state based at least in part on the first group of one or more channels or RSs having a first group identification that is higher than a second group identification of the second group of one or more channels or RSs, or applying the second TCI state based at least in part on the second group identification being lower than the second group identification.

Aspect 11: A method of wireless communication performed by a network node, comprising: transmitting an indication of a first group of one or more channels or reference signals (RSs) associated with a first transmission configuration indicator (TCI) state and a second group of one or more channels or RSs associated with a second TCI state for use in a single frequency network (SFN); and transmitting or transmitting an RS or a communication via the one or more channels using the first TCI state and the second TCI state in an SFN mode.

Aspect 12: The method of Aspect 11, further comprising: receiving an indication of support for the SFN mode.

Aspect 13: The method of any of Aspects 11-12, wherein the first group of one or more channels or RSs and the second group of one or more channels or RSs are a single group of one or more channels or RSs, and wherein one or more channels or RSs of the single group of one or more channels or RSs are configured for communication via the first TCI state and the second TCI state.

Aspect 14: The method of any of Aspects 11-13, wherein one or more of the first group of one or more channels or RSs or the second group of one or more channels or RSs comprise: downlink control channels only, downlink data channels only, or one or more downlink control channels and one or more downlink data channels.

Aspect 15: The method of any of Aspects 11-14, wherein the first group of one or more channels or RSs includes at least one channel of the second group of one or more channels or RSs.

Aspect 16: The method of any of Aspects 11-15, wherein based at least in part on a first channel or first RS being included in only one of the first group of one or more channels or RSs or the second group of one or more channels or RSs, the first channel or first RS is configured for non-SFN transmission, and wherein based at least in part on a second channel or second RS being included in both of the first group of one or more channels or RSs and the second group of one or more channels or RSs, the second channel or second RS is configured for SFN transmission.

Aspect 17: The method of any of Aspects 11-16, wherein based at least in part on a third TCI state having no channels or RSs assigned, the first group of one or more channels or RSs and the second group of one or more channels or RSs are also associated with the third TCI state.

Aspect 18: The method of Aspect 17, further comprising receiving or transmitting an additional RS or an additional communication via the third TCI state, wherein receiving or transmitting the additional RS or the additional communication via the third TCI state is allowed based at least in part on a configuration or a capability of a user equipment (UE) associated with the additional RS or the additional communication.

Aspect 19: The method of any of Aspects 11-18, further comprising: indicating a default beam for a first channel or RS based at least in part on dependency on a second channel or RS, wherein the second channel or RS is included in the first group of one or more channels or RSs and the second group of one or more channels or RSs, and wherein the first TCI state is different from the second TCI state.

Aspect 20: The method of Aspect 19, wherein signaling the default beam for the first channel or RS based at least in part on dependency on the second channel or RS comprises: indicating to apply the first TCI state based at least in part on the first TCI state having a first TCI identification that is higher than a second TCI identification of the second TCI state, indicating to apply the second TCI state based at least in part on the second TCI identification being lower than the first TCI identification, indicating to apply the first TCI state based at least in part on the first group of one or more channels or RSs having a first group identification that is higher than a second group identification of the second group of one or more channels or RSs, or indicating to apply the second TCI state based at least in part on the second group identification being lower than the second group identification.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive an indication of a first group of one or more channels or reference signals (RSs) associated with a first transmission configuration indicator (TCI) state and a second group of one or more channels or RSs associated with a second TCI state for use in a single frequency network (SFN); and
receive or transmit an RS or a communication via the one or more channels using the first TCI state and the second TCI state in an SFN mode.

2. The UE of claim 1, wherein the one or more processors are further configured to:
transmit an indication of support for the SFN mode.

3. The UE of claim 1, wherein the first group of one or more channels or RSs and the second group of one or more channels or RSs are a single group of one or more channels or RSs, and
wherein one or more channels or RSs of the single group of one or more channels or RSs are configured for communication via the first TCI state and the second TCI state.

4. The UE of claim 1, wherein one or more of the first group of one or more channels or RSs or the second group of one or more channels or RSs comprise:
downlink control channels only,
downlink data channels only, or
one or more downlink control channels and one or more downlink data channels.

5. The UE of claim 1, wherein the first group of one or more channels or RSs includes at least one channel of the second group of one or more channels or RSs.

6. The UE of claim 1, wherein based at least in part on a first channel or first RS being included in only one of the first group of one or more channels or RSs or the second group of one or more channels or RSs, the first channel or first RS is configured for non-SFN transmission, and
wherein based at least in part on a second channel or second RS being included in both of the first group of one or more channels or RSs and the second group of one or more channels or RSs, the second channel or second RS is configured for SFN transmission.

7. The UE of claim 1, wherein based at least in part on a third TCI state having no channels or RSs assigned, the first group of one or more channels or RSs and the second group of one or more channels or RSs are also associated with the third TCI state.

8. The UE of claim 7, wherein the one or more processors are further configured to receive or transmit an additional RS or an additional communication via the third TCI state,
wherein receiving or transmitting the additional RS or the additional communication via the third TCI state is allowed based at least in part on a configuration or a capability of the UE.

9. The UE of claim 1, wherein the one or more processors are further configured to:
determine a default beam for a first channel or RS based at least in part on dependency on a second channel or RS,
wherein the second channel or RS is included in the first group of one or more channels or RSs and the second group of one or more channels or RSs, and
wherein the first TCI state is different from the second TCI state.

10. The UE of claim 9, wherein the one or more processors, to determine the default beam for the first channel or RS based at least in part on dependency on the second channel or RS, are configured to:
apply the first TCI state based at least in part on the first TCI state having a first TCI identification that is higher than a second TCI identification of the second TCI state,
apply the second TCI state based at least in part on the second TCI identification being lower than the first TCI identification,
apply the first TCI state based at least in part on the first group of one or more channels or RSs having a first group identification that is higher than a second group identification of the second group of one or more channels or RSs, or
apply the second TCI state based at least in part on the second group identification being lower than the second group identification.

11. A network node for wireless communication, comprising:
a memory; and
one or more processors, coupled to the memory, configured to:
transmit an indication of a first group of one or more channels or reference signals (RSs) associated with a first transmission configuration indicator (TCI) state and a second group of one or more channels or RSs associated with a second TCI state for use in a single frequency network (SFN); and
transmit or transmitting an RS or a communication via the one or more channels using the first TCI state and the second TCI state in an SFN mode.

12. The network node of claim 11, wherein the one or more processors are further configured to:
receive an indication of support for the SFN mode.

13. The network node of claim 11, wherein the first group of one or more channels or RSs and the second group of one or more channels or RSs are a single group of one or more channels or RSs, and
wherein one or more channels or RSs of the single group of one or more channels or RSs are configured for communication via the first TCI state and the second TCI state.

14. The network node of claim 11, wherein one or more of the first group of one or more channels or RSs or the second group of one or more channels or RSs comprise:
downlink control channels only,
downlink data channels only, or
one or more downlink control channels and one or more downlink data channels.

15. The network node of claim 11, wherein the first group of one or more channels or RSs includes at least one channel of the second group of one or more channels or RSs.

16. The network node of claim 11, wherein based at least in part on a first channel or first RS being included in only one of the first group of one or more channels or RSs or the second group of one or more channels or RSs, the first channel or first RS is configured for non-SFN transmission, and
wherein based at least in part on a second channel or second RS being included in both of the first group of one or more channels or RSs and the second group of one or more channels or RSs, the second channel or second RS is configured for SFN transmission.

17. The network node of claim 11, wherein based at least in part on a third TCI state having no channels or RSs assigned, the first group of one or more channels or RSs and the second group of one or more channels or RSs are also associated with the third TCI state.

18. The network node of claim 17, wherein the one or more processors are further configured to receive or transmit an additional RS or an additional communication via the third TCI state,
wherein receiving or transmitting the additional RS or the additional communication via the third TCI state is allowed based at least in part on a configuration or a capability of a user equipment (UE) associated with the additional RS or the additional communication.

19. The network node of claim 11, wherein the one or more processors are further configured to:
indicate a default beam for a first channel or RS based at least in part on dependency on a second channel or RS,
wherein the second channel or RS is included in the first group of one or more channels or RSs and the second group of one or more channels or RSs, and
wherein the first TCI state is different from the second TCI state.

20. The network node of claim 19, wherein the one or more processors, to signal the default beam for the first channel or RS based at least in part on dependency on the second channel or RS, are configured to:
indicate to apply the first TCI state based at least in part on the first TCI state having a first TCI identification that is higher than a second TCI identification of the second TCI state,
indicate to apply the second TCI state based at least in part on the second TCI identification being lower than the first TCI identification,
indicate to apply the first TCI state based at least in part on the first group of one or more channels or RSs having a first group identification that is higher than a second group identification of the second group of one or more channels or RSs, or
indicate to apply the second TCI state based at least in part on the second group identification being lower than the second group identification.

21. A method of wireless communication performed by a user equipment (UE), comprising:
receiving an indication of a first group of one or more channels or reference signals (RSs) associated with a first transmission configuration indicator (TCI) state and a second group of one or more channels or RSs associated with a second TCI state for use in a single frequency network (SFN); and
receiving or transmitting an RS or a communication via the one or more channels using the first TCI state and the second TCI state in an SFN mode.

22. The method of claim 21, wherein based at least in part on a first channel or first RS being included in only one of the first group of one or more channels or RSs or the second group of one or more channels or RSs, the first channel or first RS is configured for non-SFN transmission, and
wherein based at least in part on a second channel or second RS being included in both of the first group of one or more channels or RSs and the second group of one or more channels or RSs, the second channel or second RS is configured for SFN transmission.

23. The method of claim 21, wherein based at least in part on a third TCI state having no channels or RSs assigned, the first group of one or more channels or RSs and the second group of one or more channels or RSs are also associated with the third TCI state.

24. The method of claim 21, further comprising:
determining a default beam for a first channel or RS based at least in part on dependency on a second channel or RS,
wherein the second channel or RS is included in the first group of one or more channels or RSs and the second group of one or more channels or RSs, and
wherein the first TCI state is different from the second TCI state.

25. The method of claim 24, wherein determining the default beam for the first channel or RS based at least in part on dependency on the second channel or RS comprises:
applying the first TCI state based at least in part on the first TCI state having a first TCI identification that is higher than a second TCI identification of the second TCI state,
applying the second TCI state based at least in part on the second TCI identification being lower than the first TCI identification,
applying the first TCI state based at least in part on the first group of one or more channels or RSs having a first group identification that is higher than a second group identification of the second group of one or more channels or RSs, or
applying the second TCI state based at least in part on the second group identification being lower than the second group identification.

26. A method of wireless communication performed by a network node, comprising:
transmitting an indication of a first group of one or more channels or reference signals (RSs) associated with a first transmission configuration indicator (TCI) state and a second group of one or more channels or RSs associated with a second TCI state for use in a single frequency network (SFN); and
transmitting or transmitting an RS or a communication via the one or more channels using the first TCI state and the second TCI state in an SFN mode.

27. The method of claim 26, wherein based at least in part on a first channel or first RS being included in only one of the first group of one or more channels or RSs or the second group of one or more channels or RSs, the first channel or first RS is configured for non-SFN transmission, and
wherein based at least in part on a second channel or second RS being included in both of the first group of one or more channels or RSs and the second group of one or more channels or RSs, the second channel or second RS is configured for SFN transmission.

28. The method of claim 26, wherein based at least in part on a third TCI state having no channels or RSs assigned, the first group of one or more channels or RSs and the second group of one or more channels or RSs are also associated with the third TCI state.

29. The method of claim 26, further comprising:
indicating a default beam for a first channel or RS based at least in part on dependency on a second channel or RS,
wherein the second channel or RS is included in the first group of one or more channels or RSs and the second group of one or more channels or RSs, and
wherein the first TCI state is different from the second TCI state.

30. The method of claim 29, wherein signaling the default beam for the first channel or RS based at least in part on dependency on the second channel or RS comprises:
indicating to apply the first TCI state based at least in part on the first TCI state having a first TCI identification that is higher than a second TCI identification of the second TCI state,
indicating to apply the second TCI state based at least in part on the second TCI identification being lower than the first TCI identification,
indicating to apply the first TCI state based at least in part on the first group of one or more channels or RSs having a first group identification that is higher than a second group identification of the second group of one or more channels or RSs, or
indicating to apply the second TCI state based at least in part on the second group identification being lower than the second group identification.
